(19) United States
(12) Patent Application Publication
(10) Pub. No.: US 2026/0214553 A1
(43) Pub. Date: Jul. 23, 2026

(54) METHODS, ARCHITECTURES, APPARATUSES AND SYSTEMS FOR ENHANCED SYSTEM INFORMATION ACQUISITION IN CELL-FREE MIMO DEPLOYMENTS

(71) Applicant: InterDigital Patent Holdings, Inc., Wilmington, DE (US)

(72) Inventors: Patrick SVEDMAN, Stockholm (SE); Allan Yingming TSAI, Boonton, NJ (US); Kyle Jung-Lin PAN, Saint James, NY (US); Javier LORCA HERNANDO, Madrid (ES); Arman SHOJAEIFARD, London (GB); Guodong ZHANG, Woodbury, NY (US)

(21) Appl. No.: 19/138,705

(22) PCT Filed: Dec. 19, 2023
(86) PCT No.: PCT/US2023/084806

§ 371 Date: Jun. 13, 2025

Related U.S. Application Data
(60) Provisional application No. 63/434,195, filed on Dec. 21, 2022.

(51) Int. Cl. H04W 48/12

(52) U.S. Cl. CPC H04W 48/12

(57) ABSTRACT

Procedures, methods, architectures, apparatuses, systems, devices, and computer program products are described for enhanced System information (SI) message acquisition, in particular in cell-free Multiple Input Multiple Output (MIMO) deployments. For example, a wireless transmit/receive unit (WTRU) is configured to receive, based on a first physical cell identity (PCI), a synchronization signal block (SSB); decode a payload of the SSB, wherein the payload comprises information indicating a resource set and search space configuration; receive, based on the first PCI and the resource set and search space configuration, a system information block (SIB); determine, based on the SIB, information indicating a second PCI, wherein the second PCI is different from the first PCI; and receive, based on the second PCI, a scheduled transmission comprising system information, wherein the scheduled transmission is quasi-colocated (QCL) with the SSB.

### CROSS-REFERENCE TO RELATED APPLICATIONS

This application claims the benefit of U.S. Provisional Patent Application No. 63/434,195 filed Dec. 21, 2022; which is incorporated herein by reference.

### BACKGROUND

The present disclosure is generally directed to the fields of communications, software and encoding, including, for example, to methods, architectures, apparatuses, systems related to enhanced system information (SI) message acquisition, in particular in cell-free Multiple Input Multiple Output (MIMO) deployments.

### SUMMARY

SI overhead reduction in cell-free MIMO deployment based on legacy synchronization signal/physical broadcast channel (PBCH) blocks (SSBs) is provided. In 5G New Radio (NR), SI messages are transmitted per SSB and per physical cell Id (PCI), which may result in significant overhead in a super cell.

Enhanced SI message acquisition is disclosed, in which a WTRU (e.g., UE) receives an SI message using an anchor PCI in a super cell, rather than the PCI of the detected SSB. Furthermore, joint SI message transmission across multiple SSBs with a PCI is disclosed.

Methods and apparatus for enhanced SI message acquisition are provided. In one embodiment, a method includes an anchor PCI for SI message reception configured in SIB1. The anchor PCI may be different from the PCI of the detected SSB and the PCI used for receiving SI block type 1 (SIB1). The method further includes receiving by a WTRU (e.g., UE) an SI message using the anchor PCI. The method further includes an SSB group for SI message reception configured in SIB1. The detected SSB is in the SSB group. The method further includes a WTRU (e.g., UE) receiving an SI message on time-frequency resources associated with the SSBs in the SSB group. The WTRU (e.g., UE) may operate with (e.g., assume that) the SI message being quasi co-location (QCL) with the SSBs in the SSB group.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates points in the context of transmission and reception point(s) (TRP(s)) and/or reception point(s) (RP(s));

FIG. 3 illustrates a cell with two TRPs and four SSBs;

FIG. 4 illustrates SSBs and physical downlink control channel (PDCCH)/physical data shared channel (PDSCH) for SIB1 acquisition in 5G NR;

FIG. 5 illustrates enhanced SI acquisition in a super cell;

FIG. 6 is a system diagram illustrating a procedure for enhanced SI message acquisition;

FIG. 7 is a system diagram illustrating a further procedure for enhanced SI message acquisition;

FIG. 8 illustrates joint multi-TRP transmission of SI message;

FIG. 9 illustrates joint multi-TRP transmission of SI message;

FIG. 10 illustrates SI message transmission using SSB groups in super cell with multiple PCIs;

FIG. 11 is a system diagram illustrating a further procedure for enhanced SI message acquisition;

FIG. 12 illustrates joint multi-TRP transmission of an SI message in a first occasion and a second occasion;

FIG. 13 illustrates enhanced SI acquisition in a super cell.

FIG. 14 is a system diagram illustrating a further procedure for enhanced SI message acquisition;

FIG. 15 is a diagram illustrating another method of enhanced SI message acquisition; and

FIG. 16 is a diagram illustrating another method of enhanced SI message acquisition.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

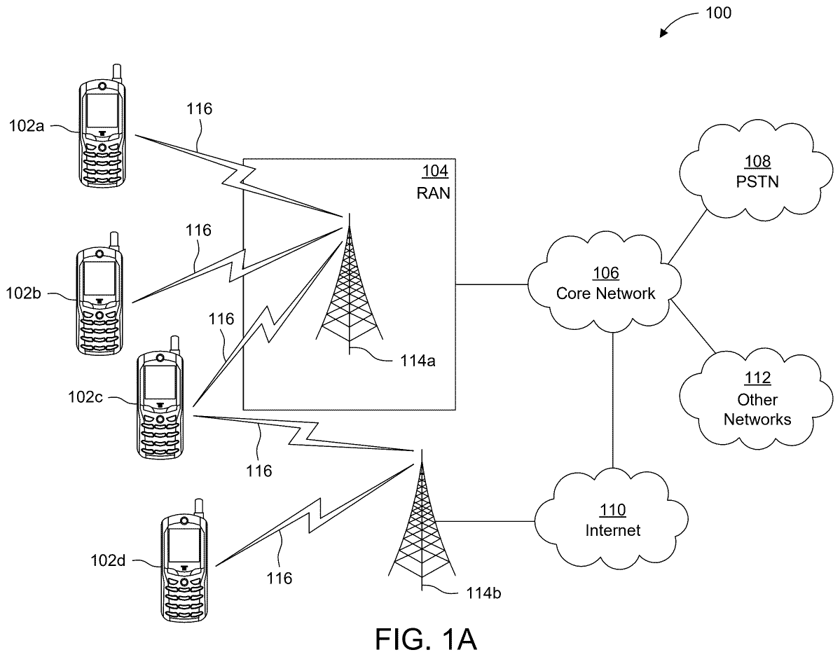

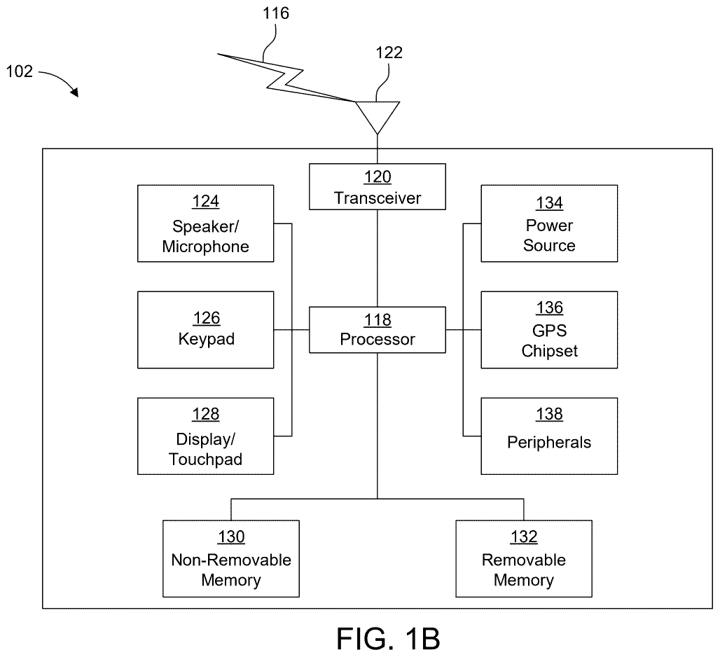

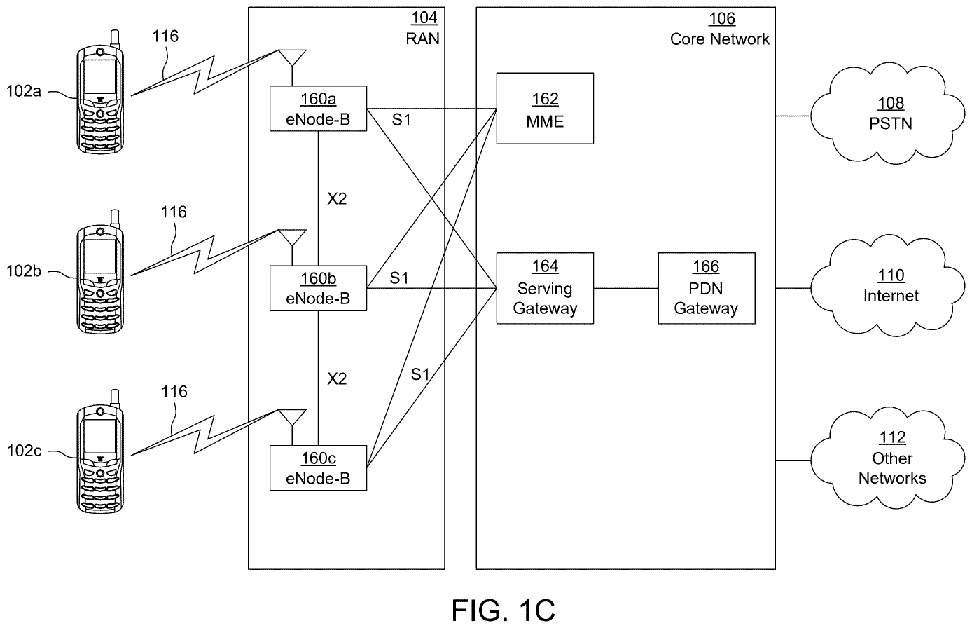

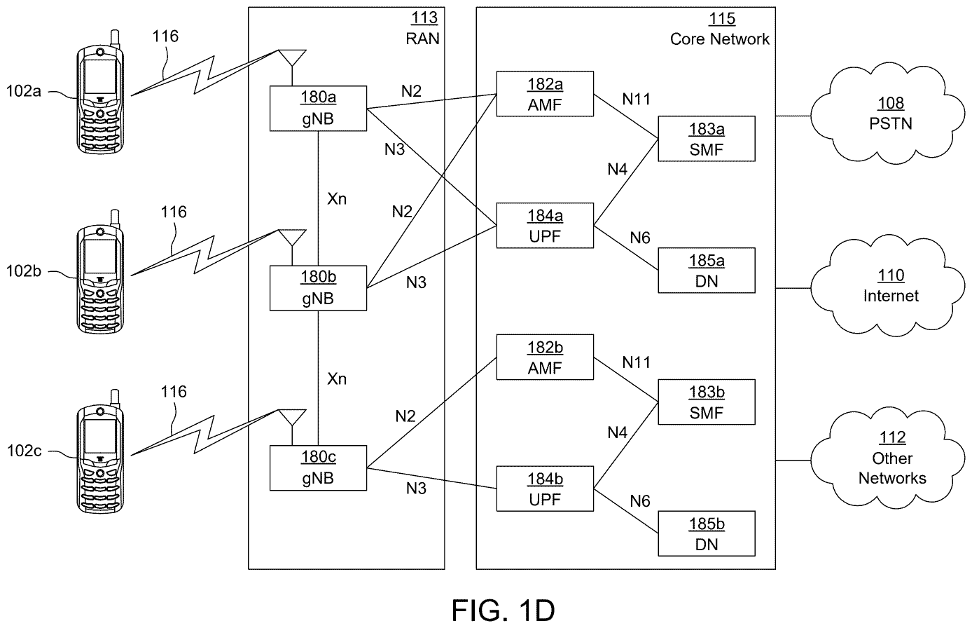

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite.

The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.1 lac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In a super cell containing SSBs with multiple PCIs, the amount of system information (SI) transmissions may grow with the number of PCIs. In the following description, methos and apparatus are provided to propose various enhancements to reduce the overhead associated with SI transmission in a super cell.

Enhanced acquisition of SI messages that carry SI other than MIB and SIB1 may be considered. Instead of receiving an SI message with the PCI of the detected SSB, the WTRU 102 (e.g., UE) may use an anchor PCI for SI message reception. This may introduce the possibility of joint transmission of SI messages in the super cell.

Further enhanced SI message acquisition may consider joint transmission of an SI message using a group of SSB beams, thereby reducing the need for time multiplexing SI message transmissions corresponding to different SSBs.

### Cell-Free MIMO Deployments

Wireless communication between one or more WTRUs 102 (e.g., UEs) and a network is considered herein. The network, e.g., in the vicinity of a particular WTRU 102 (e.g., UE), may include transmission and reception points (TRPs). TRPs may be called interchangeably “distributed antenna system” (DAS), “remote radio head” (RRH), “access point” (AP), or distributed MIMO in various contexts.

A TRP may both transmit signals and/or channels to one or more WTRUs 102 (e.g., UEs), usually called the downlink (DL), and may receive signals and/or channels from one or more WTRUs 102 (e.g., UEs), usually called the uplink (UL). In some cases, a TRP may act as a WTRU 102 (e.g., UE), e.g., when acting as a relay wherein the TRP may act as a WTRU 102 (e.g., UE) and interact with another node to receive DL data which may be then relayed to a WTRU 102 (e.g., UE), or wherein the TRP may act as a WTRU 102 (e.g., UE) and relay UL data received from a WTRU 102 (e.g., UE) to a base station.

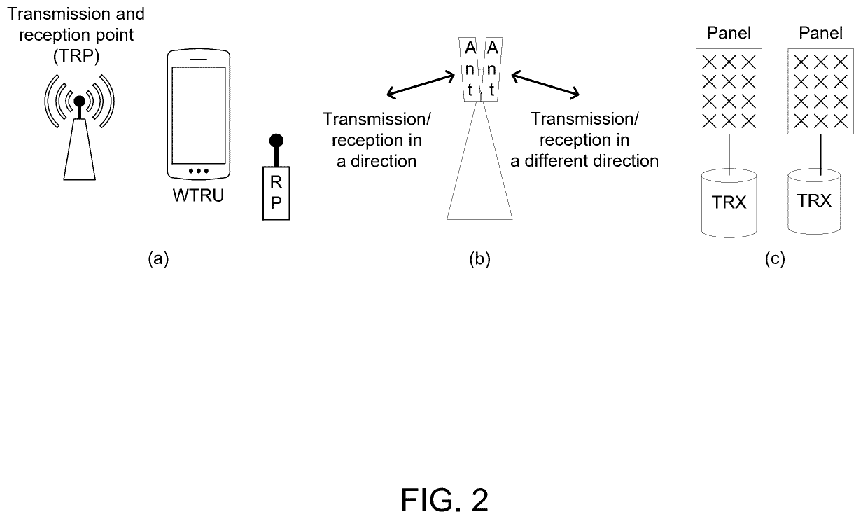

FIG. 2 shows illustrations of points in the context of TRP(s) and/or RP(s). In (a), there are two geographically separated points in the vicinity of a WTRU 102 (e.g., UE), a TRP and an RP. In (b), there are two TRPs in roughly the same geographical location in the form of two antennas (indicated by ‘Ant’ in the figure) mounted on the same site, but with main transmission/sensitivity directions (boresights) in significantly different directions. In (c), there are two panels, each associated with a point, each comprising a rectangular array of cross-polarized antenna elements (in the form of ‘X’s in the figure). Each panel is connected to a different TRX chain in this illustration.

In the context of TRPs, different points may be geographically separated (see FIG. 2(a)). In some cases, different points may be located in approximately the same geographical location, but separated in some other way, for example the boresight(s) of the antenna(s) (or antenna element(s)) of a first point are significantly different from the boresight(s) of the antenna(s) of a second point.

An example of the latter is a cellular communication site serving multiple sectors in different directions, using different sets of antennas. In this case, the different sets of antennas serving different sectors in different directions from the site may be considered different points. This is illustrated in FIG. 2(b).

According to embodiments, antennas may be arranged in one or more panels, where a panel for example comprises a rectangular panel with N×M antenna elements, as illustrated in FIG. 2 (c). According to embodiments, all or a subset of the antenna elements of a panel may be connected to the same transmitter and receiver (TRX) chain or the same receiver (RX) chain. According to embodiments, antenna elements of different panels are connected to different transmitter and receiver (TRX) chains or different receiver (RX) chains. According to embodiments, different panels, which may or may not be geographically co-located, may correspond to different points. According to embodiments, different panels may correspond to the same point.

According to embodiments, a point may operate on multiple frequencies, for example two frequencies. According to embodiments, a site (incl. for example one antenna, an antenna array, a panel, a subset of antennas per frequency) in a geographic location with a particular transmission/reception direction on the multiple frequencies may count as multiple points, at least from the point of view of a WTRU (e.g., UE). One reason may be that the radio signal propagation properties on the different frequencies are different. Another reason may be that the hardware at the network side results in signal transmission and/or reception differences on the different frequencies, for example different oscillators, calibration hardware for beam correspondence, phase shifters for beamforming etc.

A signal/channel received at a TRP may be subject to further processing, e.g., filtering, amplification, down-conversion, A/D conversion (sampling), digitally signal processing, demodulation, channel decoding, etc. A signal/channel transmitted at a TRP may have been subject to various processing prior to transmission, e.g., filtering, amplification, peak-to-average power reduction, up-conversion, D/A conversion, digital signal processing, modulation, channel encoding, etc. A subset (e.g., none, some or all) of these operations for reception/transmission may be performed at the TRP while other operations may be performed at one or more other location(s) connected with the TRP, e.g., through a fronthaul or backhaul link, e.g., by optical fiber, copper wire, over-the-air. In a centralized RAN (CRAN) implementation, signal processing for multiple points is performed at a centralized location.

### Massively Distributed MIMO

Additional TRPs in a cell may provide a reduced average distance and/or pathloss between a WTRU 102 (e.g., UE) and the nearest TRP, for example allowing lower transmit power and lower interference in the system. Additional TRPs in a cell may improve spatial diversity, which means that there may be several candidate TRPs that may serve a WTRU 102 (e.g., UE). If the radio link to a serving TRP is blocked, the WTRU 102 (e.g., UE) may instead be served by another TRP without a blocked radio link.

In a distributed MIMO system, the antennas might not be located at one or a few TRPs. Instead, the antennas are even more distributed throughout the wireless network. In some definitions, distributed MIMO may include the case with a few TRPs, e.g., coherent joint transmission/reception involving a few TRPs.

A massively distributed MIMO system (also called distributed massive MIMO) may combine the large number of antennas in a massive MIMO system with the distributed antennas in a distributed MIMO system. For example, the hundreds of antennas previously co-located at a massive MIMO TRP that covers a geographic area may be distributed throughout the area. Subsets of antennas may be co-located at TRPs (sometimes called access points). The massively distributed MIMO deployment may provide very high theoretical performance under ideal assumptions. However, there are numerous challenges to achieve those performance gains in practice, including fronthaul, synchronization, etc.

### Cell-Free MIMO

Legacy cellular networks are based on the concept that a (typically) small number of TRPs transmit and receive signals corresponding to a cell in a frequency band. A frequency band in which multiple cells operate may be called a frequency layer. It may be characterized by a range of frequencies, a center (e.g., carrier) frequency, a bandwidth, etc. Different cells on a frequency layer may use the same or different center frequencies and/or bandwidths.

The geographic area served by a cell may be typically static. As a WTRU 102 (e.g., UE) moves through the network, it may (e.g., need to) be handed over from cell to cell. Intra-frequency handovers, i.e., handovers between cells in the same frequency band, typically occur at cell edges, where quality-of-service is typically low.

The idea of cell-free operation is that instead of moving across more or less static cells, the cell serving a WTRU 102 (e.g., UE) may move with the WTRU 102 (e.g., UE). From the WTRU's 102 (e.g., UE's) perspective, no, or at least much fewer, intra-frequency handovers may be used (e.g., needed).

Another potential benefit of cell-free operation may be that deteriorating quality-of-service at the cell edge could be avoided. This may be realized by having a set of nearby TRPs serve a WTRU 102 (e.g., UE), rather than using a set of TRPs that may (e.g., need to) be associated with the serving cell.

Cell-free operation in a massively distributed MIMO deployment may be called cell-free MIMO. The WTRU-centric “cell” can be operated by TRPs/antennas that are close to the WTRU 102 (e.g., UE), resulting in high and uniform quality-of-service.

### SS/PBCH Blocks (SSBs) in 5G NR

The SS/PBCH block (SSB) is the signal/channel in 5G NR most connected to cell-based operation.

An SSB may comprise a primary synchronization signal (PSS), a secondary synchronization signal (SSS), a physical broadcast channel (PBCH), and a PBCH demodulation reference signal (DMRS).

There may be up to 4, 8, or 64 SSBs in a cell, for example, depending on the frequency range of the cell. Lower frequencies may support fewer SSBs while higher frequencies, e.g., millimeter wave, may support up to 64 SSBs in a cell. Different SSBs may correspond to different SSB indices.

For various reasons, an SSB (with a certain SSB index) might not be transmitted on the nominal time-frequency resource assigned to the SSB. It may be more suitable to denote SSBs as candidate SSBs and to denote an SSB index as candidate SSB index. For brevity, the terms SSB and SSB index are used herein, but they may refer to candidate SSB and candidate SSB index, respectively.

### Physical Cell Id (PCI)

The physical cell Id (PCI) may be used to identify a cell on a carrier frequency. It may be used to generate various cell-specific signals/channels, for example PSS and SSS.

The NR PCI

$${N}_{ID}^{cell} ∈ \{ 0 , 1 , ... , 1008 \}$$

may be constructed from two other IDs,

$${N}_{ID}^{( 1 )} ∈ \{ 0 , 1 , ... , 335 \} and {N}_{ID}^{( 2 )} ∈ \{ 0 , 1 , 2 \} , as {N}_{ID}^{cell} = 3 {N}_{ID}^{( 1 )} + {N}_{ID}^{( 2 )} .$$

### Primary Synchronization Signal (PSS)

The PSS may be used by a WTRU 102 (e.g., UE), for example for cell search and/or coarse time- and frequency synchronization. The sequence used for PSS may be based on

$${N}_{ID}^{( 2 )} .$$

### Secondary Synchronization Signal (SSS)

The SSS may be used by a WTRU 102 (e.g., UE), for example, for any of: further synchronization, channel estimation, SSB-based measurements, e.g., reference signal received power (RSRP), and determining the PCI. The sequence used for SSS may be based on both

$${N}_{ID}^{( 1 )} and {N}_{ID}^{( 2 )} .$$

### Physical Broadcast Channel Demodulation Reference Signal (PBCH DMRS)

The PBCH DMRS may be used by a WTRU 102 (e.g., UE) for example for further synchronization, channel estimation, and SSB-based measurements, in addition to the SSS.

The PBCH DMRS sequence may be based on any of: (1) the PCI, (2) the SSB index, (3) the least significant bits (LSB) thereof, and (4) the half-frame index. The WTRU 102 (e.g., UE) may obtain some degree of sub-frame and/or frame timing upon reception of PBCH DMRS.

A sub-carrier offset may be applied to the PBCH DMRS that is based on (e.g., depends on) the PCI mod 4.

### Physical Broadcast Channel (PBCH)

The PBCH payload may comprise the master information block (MIB) as well as timing-related information (8 bits) that may not be included in the MIB. The timing-related information may include the most significant bits (MSB) of the SSB index and/or the half-frame index.

### MIB

MIB may contain information (e.g., necessary) to receive SIB1 as well as other information, as described in the table below.

| | Number | |
|---|---|---|
| Field name | of bits | Description |
| systemFrameNumber | 6 | The MSBs of the SFN. |
| subCarrierSpacingCommon | 1 | Subcarrier spacing for SIB1, Msg. 2/4 and Msg B for |
| | | initial access, paging and broadcast SI-messages. If |
| | | the WTRU 102 (e.g., UE) acquires this MIB on an |
| | | FR1 carrier frequency, the value scs15or60 |
| | | corresponds to 15 kHz and the value scs30or120 |
| | | corresponds to 30 kHz. If the WTRU 102 (e.g., UE) |
| | | acquires this MIB on an FR2 carrier frequency, the |
| | | value scs15or60 corresponds to 60 kHz and the value |
| | | scs30or120 corresponds to 120 kHz. |
| ssb-SubcarrierOffset | 4 | Corresponds to k_{SSB} which is the frequency domain |
| | | offset between SSB and the overall resource block |
| | | grid in number of subcarriers. The value range of this |
| | | field may be extended by an additional most |
| | | significant bit encoded within PBCH. This field may |
| | | indicate that this cell does not provide SIB1 and that |
| | | there is hence no CORESET#0 configured in MIB. In |
| | | this case, the field pdcch-ConfigSIB1 may indicate the |
| | | frequency positions where the WTRU 102 (e.g., UE) |
| | | may (not) find a SS/PBCH with a control resource set |
| | | and search space for SIB1. |
| dmrs-TypeA-Position | 1 | Position of (first) DMRS for downlink |
| pdcch-ConfigSIB1 | 8 | Determines a common ControlResourceSet |
| | | (CORESET), a common search space and necessary |
| | | PDCCH parameters. If the field ssb-SubcarrierOffset |
| | | indicates that SIB1 is absent, the field pdcch- |
| | | ConfigSIB1 indicates the frequency positions where |
| | | the WTRU 102 (e.g., UE) may find SS/PBCH block |
| | | with SIB1 or the frequency range where the network |
| | | does not provide SSB with SIB1. |
| cellBarred | 1 | One value means that the cell is barred. This field is |
| | | ignored by IAB-MT and for connectivity to NTN. |
| intraFreqReselection | 1 | Controls cell selection/reselection to intra-frequency |
| | | cells when the highest ranked cell is barred or treated |
| | | as barred by the WTRU 102 (e.g., UE). This field is |
| | | ignored by IAB-MT. |
| spare | 1 | Spare bit. |

Some cells might not support initial access and might not provide, i.e., transmit, SIB1. Some values of the subcarrier offset k_{SSB} may indicate that SIB11 is not broadcasted on the cell. If the WTRU 102 (e.g., UE) cannot proceed with initial access on the cell, it may (e.g., does not need to) not know the subcarrier offset.

If the cell provides SIB1, the field pdcch-ConfigSIB1 may correspond to an IE with a 4-bit field (controlResourceSetZero) that determines a common CORESET with TD #0 and/or a 4-bit field (searchSpaceZero) that determines a common search space with ID #0.

If the cell does not provide SIB1, i.e., k_{SSB} is within a certain range, the value of k_{SSB} and/or pdcch-ConfigSIB1 may provide an indication of another global synchronization channel number (GSCN) that does provide SIB1.

### SIB1 in 5G NR

System information in 5G NR may be divided into multiple parts, called system information blocks (SIBs). One or more SIBs may be carried in a PDSCH, which may be broadcasted in the cell. Different SIBs may correspond to different kinds of system information. A WTRU 102 (e.g., UE) may choose to receive (e.g., only) a subset of the SIBs.

The SIB1 comprises various system information, e.g., how to perform random access to connect to the cell and/or scheduling information of other SIBs. During initial access, the WTRU 102 (e.g., UE) may receive SIB1 that may be broadcasted in the cell. For handover or serving cell addition, contents of SIB1 may be conveyed using dedicated signaling. Here, the broadcasting of SIB1 that can be received by a WTRU 102 (e.g., UE), for example, in IDLE mode is described.

MIB and SIB1 may comprise the minimum system information.

### Scheduling and Transmission of SIB1

A cell that broadcasts SIB1 may configure a CORESET #0 and/or search space #0 with the field pdcch-ConfigSIB1 in the MIB, which may indicate where the WTRU 102 (e.g., UE) can receive the PDCCH that may schedule the PDSCH that carries SIB1. The slot and/or symbols in which the WTRU 102 (e.g., UE) can receive and decode the PDCCH may use (e.g., depend on) the SSB index of the detected SSB. There may be a one-to-one association between SSBs and disjoint sets of time multiplexed PDCCH monitoring occasions. The association may imply that the WTRU 102 (e.g., UE) may receive the PDCCH with the same time-frequency synchronization and/or spatial parameter (e.g., WTRU Rx beam) as was used to receive the SSB, i.e., the WTRU 102 (e.g., UE) may operate with (e.g., assume that) the PDCCH and PDSCH being quasi co-located (QCL) with the corresponding SSB. This may provide support for SSB-based early beam management prior to system information acquisition.

The periodicity of a search space associated with an SSB may be 2 radio frames or equal to the SSB periodicity, depending on the CORESET multiplexing pattern. A PDSCH carrying SIB1 may be transmitted with the same periodicity.

The PDCCH and PDSCH for SIB1 may be received within the initial DL bandwidth part (BWP), which spans the bandwidth of CORESET #0. The bandwidth may be (e.g., typically) relatively low, which may mean that PDSCHs corresponding to different SSBs may be typically multiplexed in time rather than in frequency. Some TRPs might not be capable of simultaneously transmitting with multiple different SSB beams. For example, due to the time multiplexing of both PDCCH and PDSCH for SIB1, the number of symbols and the overhead used for SIB1 transmission may grow with the number of SSBs.

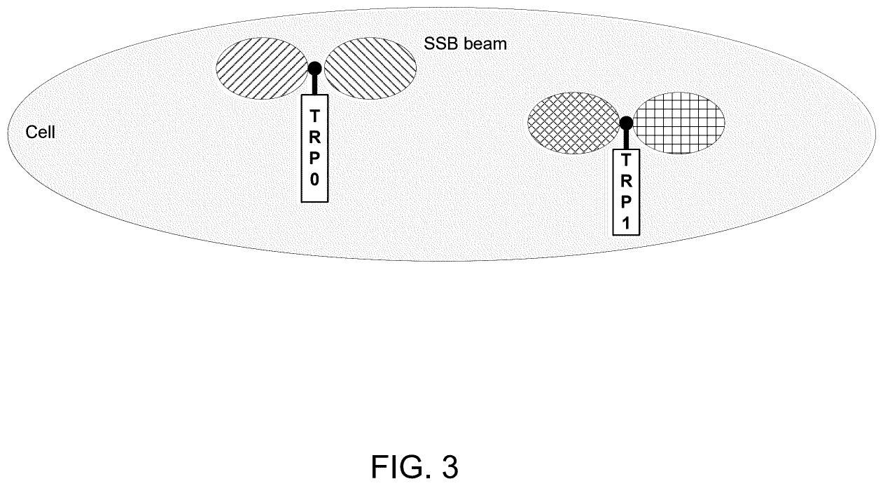

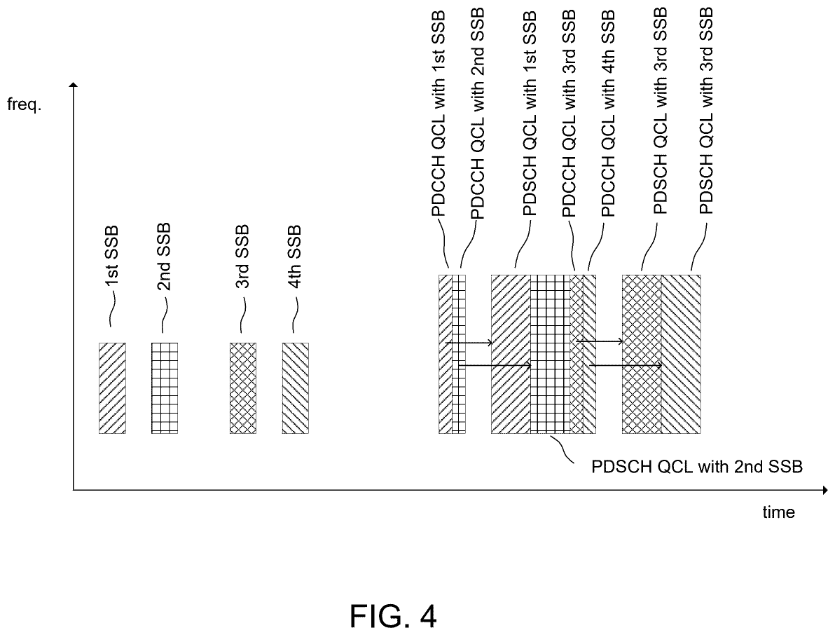

FIG. 3 shows an example cell with two TRPs and two SSB beams per TRP. Hence, the number of SSBs in the cell is four. The different patterns in the SSB beams may correspond to different SSBs, e.g., different SSB indices. FIG. 4 illustrates the transmission of four SSBs in a cell, with corresponding CORESET/search spaces for reception of PDCCH that schedules PDSCH that carries SIB1, using CORESET multiplexing pattern 1. In this pattern, CORESET #0 may overlap in frequency with the SSB, at least partly. The four shown PDCCH monitoring occasions each may correspond to a different SSB so that the WTRU 102 (e.g., UE) may operate with (e.g., assume that) the PDCCH (incl. its DMRS) being QCL with the corresponding SSB. The system information broadcast overhead may grow with the number of SSBs in the cell. The arrow in the figure between a PDCCH and a corresponding PDSCH may transmit information indicating that the PDSCH is scheduled by the PDCCH.

In CORESET multiplexing pattern 2, the PDCCH monitoring occasions for CORESET #0 may occur (e.g., just) before the corresponding SSB and with the same periodicity. In CORESET multiplexing pattern 3, the PDCCH monitoring occasions for CORESET #0 may occur simultaneously with the corresponding SSB and/or with the same periodicity. In pattern 2 and 3, the frequency resources for CORESET #0 may not overlap with the SSB.

### Content of SIB1

SIB1 may (e.g., typically) contain a variety of cell configurations that may be used (e.g., are needed) to access the cell.

SIB1 may contain various cell barring information, such as cell barred indication for NTN, cell barred indication for reduced capability WTRUs 102 (e.g., UEs), and unified access control. In other words, various cell barring may be indicated in both MIB and in SIB1.

SIB1 may indicate the scheduling information for the other SIBs, e.g., in the SI-SchedulingInfo information element (IE). Other SIBs may be included in SI messages, where an SI message may include one or more SIBs. SIB1 may indicate that an SI message is broadcasted in the cell or not broadcasted. If an SI message is not broadcasted, a WTRU 102 (e.g., UE) may request that it is.

An SI area may comprise a set of cells in which a SIB is valid. SIB1 may indicate an SI area ID and/or an indication per SIB (for other SIBs) if it is cell-specific or SI area specific. SIB1 may indicate a SIB value tag, e.g., an integer between 0 and 31, that may be used to indicate that the corresponding SIB has been changed, for example like a version number.

### Other SIBs in 5G NR

The term other SIB may correspond to SIBs other than MIB and SIB1. In 5G NR Rel-17 for instance, SIBs up to SIB21 have been specified.

A WTRU 102 (e.g., UE) may acquire a subset of the other SIBs, e.g., depending on its capabilities, needs, etc. The WTRU 102 (e.g., UE) may for example acquire SI based on any of: upon cell selection (e.g. upon power on), cell-reselection, return from out of coverage, after reconfiguration with sync completion, after entering the network from another radio access technology, upon receiving an indication that the system information has changed, upon receiving a public warning system (PWS) notification, upon receiving request (e.g., a positioning request) from upper layers; and whenever the WTRU 102 (e.g., UE) does not have a valid version of a stored SIB or a valid version of a requested SIB.

A WTRU 102 (e.g., UE) may store an acquired SIB and various parameters associated with the SIB. If the stored SIB is (e.g., still) valid for the cell, the WTRU 102 (e.g., UE) might not (e.g., need to) re-acquire the SIB.

For example, if the stored SIB is associated with a cell, e.g., it was received in the cell, and with the same stored SIB value tag as the SIB value tag included in the latest SIB scheduling info (e.g., in SI-SchedulingInfo IE) received from the cell, the stored SIB may be (e.g., still) valid for the cell.

In another example, a WTRU 102 (e.g., UE) may (e.g., first) acquire a SIB in a first cell with a first SI tracking area ID and with a first SIB value tag, and the WTRU 102 (e.g., UE) may store the acquired SIB and the associated parameters. The stored SIB may be valid in a second cell if the latest SIB scheduling info (e.g., in SI-SchedulingInfo IE) received from the second cell includes the same SI tracking area ID as associated with the stored SIB, and the same SIB value tag as associated with the stored SIB.

The search space set for monitoring PDCCH that schedules PDSCH carrying an SI message (e.g., a Type0A-PDCCH common search space set) may be the same as or different than the search space set for monitoring PDCCH that schedules PDSCH carrying SIB1 (e.g., a Type0-PDCCH common search space set). The search space set for receiving an SI message may be configured in SIB1, for example using the searchSpaceOtherSystemInformation parameter. A WTRU 102 (e.g., UE) may monitor PDCCH for receiving an SI message in an SI window, which may have a configurable duration, for the SI message.

Cell-free MIMO deployments may be an (e.g., attractive) alternative to legacy cell-based (cellular) networks. The overhead and potential disruptions associated with handling cells can be reduced while the benefits of multi-TRP based operation can be retained.

Two aspect of legacy systems that may be (e.g., fundamentally) linked to cells are cell search and system information acquisition. In 5G NR, for example, cell search may be based on SSBs, where different SSBs may be transmitted from different TRPs or with different Tx beams from a TRP. System information delivery may be (e.g., also) connected to SSBs, since system information transmissions may be repeated per SSB.

In existing 5G NR specifications, there can be up to 4 or 8 SSBs in FR1, and up to 64 SSBs in FR2. Different SSBs in a cell may be time multiplexed. One reason may be that this allows base stations to be implemented using analog beamforming, in which a single Tx beam can be used at a time. Another reason may be that this allows all available base station transmit power to be assigned to one SSB, thereby maximizing SSB coverage. SSBs may be fundamental signals for various aspects of 5G NR, not only time-frequency synchronization, but also beam management, mobility measurements, etc. In systems with multiple TRPs and/or TRPs with hybrid/digital beamforming, time multiplexing of SSBs might not be necessary.

In future cell-free MIMO deployments, the number of TRPs and beams may increase dramatically. Therefore, a much higher number of SSBs (or equivalent system information acquisitions and cell-search) may be used (e.g., required). The increased number of SSBs may result in an increased overhead from system information transmissions. Hence, the following problem may be explored herein: the reduction of the overhead from system information message transmissions, when the number of SSBs may be increased.

Enhanced Acquisition of an SI message

### MIB and SIB1

In a super cell, SSBs with different PCIs may be used. The set of PCIs used for SSBs in a super cell may be denoted [symbol] .

MIB and SIB1 may be acquired by the WTRU 102 (e.g., UE) as in legacy 5G NR. SIB1 may be broadcasted for different PCIs in the super cell, for example for all PCIs or a subset of the PCIs in [symbol] .

For reference, an example legacy initial access procedure is described below, and may comprise any of the following steps:
1. A WTRU 102 (e.g., UE) may detect an SSB.
2. The WTRU 102 (e.g., UE) may decode the PBCH payload, incl. MIB, in the SSB.
3. The WTRU 102 (e.g., UE) may determines cell timing (e.g., SFN, half frame, symbol timing) from the SSB and/or PBCH payload.
4. The WTRU 102 (e.g., UE) may determine that a CORESET #0 and corresponding Type0-PDCCH common search space set may be present and may determine the time-frequency resources for the CORESET and search space set from the PBCH payload.
5. The WTRU 102 (e.g., UE) may (e.g., successfully) receive a PDCCH on the CORESET and/or search space set and may decode the DCI, which may include PDSCH scheduling information.
6. The WTRU 102 (e.g., UE) may receive the PDSCH and/or may decode the transport block which may contain SIB1.

The legacy SIB1 PDCCH and/or SIB1 PDSCH may involve PCI-specific parameters, such as PDCCH/PDSCH DMRS sequence generation, interleaved CCE-to-REG mapping (e.g., shift index parameter), and PDCCH/PDSCH scrambling. Since the super cell may include SSBs [symbol] with multiple PCIs (in [symbol] ), and the WTRU 102 (e.g., UE) may use the PCI of the detected SSB to receive SIB1, separate SIB1 PDCCH and SIB1 PDSCH may be used (e.g., needed) for each PCI in the super cell that may provide SIB1. SIB1 may be additionally repeated per SSB.

Various PBCH/MIB parameters may (e.g., need to) be aligned across PCIs in a super cell, for example one or more of system frame number, subcarrier spacing for SIB1 (e.g., subCarrierSpacingCommon), SSB to resource block grid subcarrier offset (e.g., ssb-SubcarrierOffset), position of first DMRS symbol (e.g., dmrs-TypeA-Position).

Even though SIB1 may be transmitted per PCI and per SSB, the delivery of other SIBs may be enhanced.

### Enhanced Acquisition of SI Message(s)

Methods and apparatus are proposed to support reduced transmission of one or more SI messages (carrying other SIB(s)) from TRPs in the super cell compared to the per PCI and per SSB transmission of the SI messages. Methods and apparatus are proposed to improve SI message reception reliability. This may be achieved by two enhancements:
A WTRU 102 (e.g., UE) that detected an SSB and received SIB1 with a first PCI may receive an SI message using a second PCI, called an anchor PCI. The anchor PCI may be indicated in SIB1 or determined by a rule. This is further disclosed below, e.g., in section below “Other SIB Acquisition Using Anchor PCI”.
A WTRU 102 (e.g., UE) that detected a first SSB and received SIB1 based on the first SSB may receive an SI message using a group of SSBs that may include the first SSB. Receiving an SI message using a group of SSBs may correspond to operating with (e.g., assuming that) the group of SSBs as quasi co-location sources for the SI message reception and determining the same time-frequency location for PDCCH (e.g., CORESET and search space set) for the SSBs in the group of SSBs. This is further disclosed in section below “Other SIB Acquisition Using Group of SSBs”.

### Other SIB Acquisition Using Anchor PCI

One, multiple, or all, other SIBs may be valid throughout the super cell, e.g., regardless of the PCI of the SSB a WTRU 102 (e.g., UE) has detected. Consider an SI message comprising other SIBs that are valid throughout the super cell. Rather than to have a first PDCCH/PDSCH with a first PCI scheduling/carrying the SI message being time multiplexed with a second PDCCH/PDSCH with a second PCI scheduling/carrying the SI message, it could be beneficial to jointly transmit the PDCCH/PDSCH across PCIs.

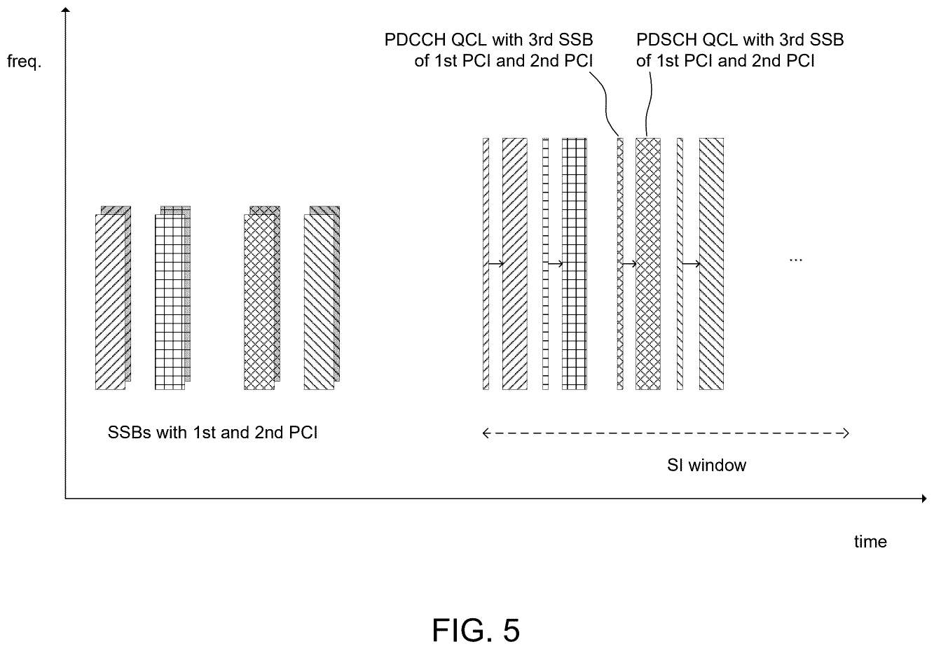

Such a scheme is illustrated in FIG. 5. Eight SSBs with two PCIs are transmitted in the super cell. The SSBs/PDCCHs/PDSCHs with white background correspond to a 1st PCI and the SSBs with grey background correspond to a 2nd PCI. An SI window corresponding to an SI message is shown, in which different PDCCH monitoring occasions correspond to different SSB indices. Note that the figure doesn't show SIB1. However, per PCI SIB1 may be operated with (e.g., assumed), so a WTRU 102 (e.g., UE) that detected an SSB with the 1st PCI may receive a SIB1 corresponding to the 1st PCI and a WTRU 102 (e.g., UE) that detected an SSB with the 2nd PCI may receive a SIB1 corresponding to the 2nd PCI. According to embodiments, enhanced SIB1 transmission may be applicable. In this example, the 1st PCI is the anchor PCI, which means that SI message may be received using the 1st PCI. The SIB1 corresponding to the 2nd PCI may indicate the same configuration for receiving the SI message as the SIB1 corresponding to the 1st PCI, but with the additional indication that the corresponding PDCCH and PDSCH may be received using the 1st PCI. Receiving a PDCCH with the anchor PCI may comprise using the anchor PCI, e.g., as parameter

$${N}_{ID}^{cell} ,$$

in PDCCH DMRS sequence generation, interleaved CCE-to-REG mapping (e.g., shift index parameter), PDCCH scrambling, etc. Receiving a PDSCH with the anchor PCI may comprise using the anchor PCI, e.g., as parameter

$${N}_{ID}^{cell} ,$$

in PDSCH DMRS sequence generation, PDSCH scrambling, etc. Even though the WTRU 102 (e.g., UE) receives the SI message using the anchor PCI, the WTRU 102 (e.g., UE) may operate with (e.g., assume that) SI message PDCCH and PDSCH being QCL with the detected SSB. In some embodiments, the WTRU 102 (e.g., UE) may operate with (e.g., assume that) both the detected SSB and the SSB with the same index as the detected SSB but with the anchor PCI being QCL sources for the SI message PDCCH and PDSCH.

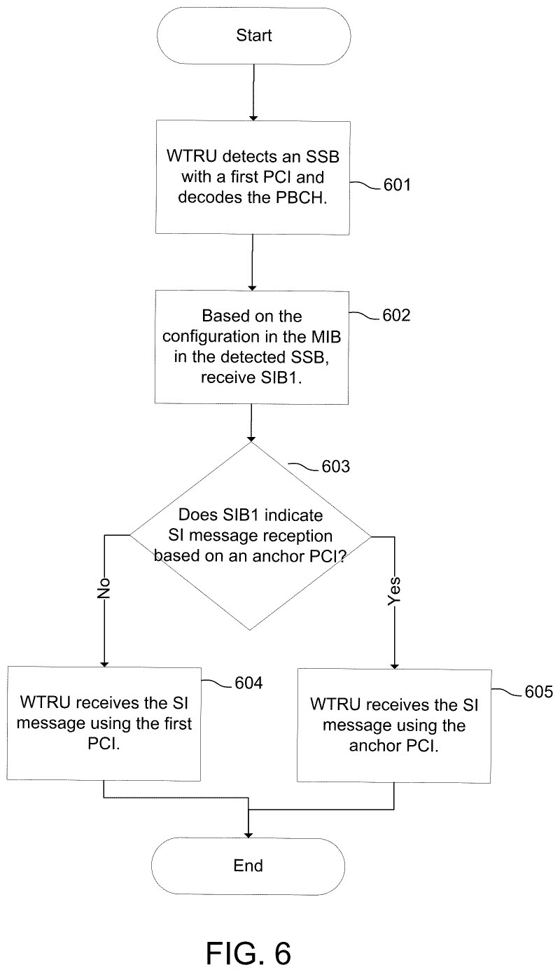

An exemplary WTRU (e.g., UE) procedure is illustrated in FIG. 6. In step 601, the WTRU 102 (e.g., UE) may detect an SSB with a first PCI and may decode the corresponding PBCH, which may include the MIB, as in legacy procedures. In step 602, the WTRU 102 (e.g., UE) may receive a PDCCH that may schedule a PDSCH that may carry SIB1, e.g., based on the configuration in the MIB, which may also follow legacy procedures.

In step 6033, the WTRU 102 (e.g., UE) may determine if the reception of an SI message is based on an anchor PCI. If so, the WTRU 102 (e.g., UE) may receive the SI message using the anchor PCI, in step 605. According to embodiments, both the PDCCH and the PDSCH may be received using the anchor PCI. According to embodiments, the PDCCH may be received using the first PCI while the PDSCH may be received using the anchor PCI. The PDCCH that may schedule a PDSCH that may carry a SI message may indicate whether the PDSCH may be to be received using the first PCI or the anchor PCI. SIB1 may indicate the anchor PCI. SIB1 or another SIB may indicate the set of PCIs used in the super cell ( ).

[symbol]

If the SI message is received with an anchor PCI that may be different from the first PCI, the WTRU 102 (e.g., UE) may use the detected SSB with the first PCI as a QCL source in the case of (e.g., when) receiving the PDCCH and/or PDSCH. According to embodiments, the WTRU 102 (e.g., UE) may use the SSB with an anchor PCI but with the same SSB index as the detected SSB as a QCL source. According to embodiments, the WTRU 102 (e.g., UE) may use the detected SSB (with the first PCI) and the same SSB (with the anchor PCI) as QCL sources in the case of (e.g., when) receiving the SI message PDCCH and/or PDSCH.

If the SIB1 didn't indicate SI message reception using the anchor PCI, the WTRU 102 (e.g., UE) may receive the SI message using the first PCI in step 604.

To support SIB acquisition using an anchor PCI, e.g., with joint transmission using SSB beams corresponding to different PCIs, various configurations may (e.g., need to) be aligned across the SIB1s with different PCIs in the super cell. For example, parameters corresponding to the SIB1-defined resource block grid and DL BWPs may (e.g., need to) be aligned across the SIB1s. The CORESET and search space set configurations for PDCCH scheduling PDSCH carrying SI messages may (e.g., need to) be aligned, so that the same PDCCH can be decoded by WTRUs 102 (e.g., UEs) that have decoded SIB1s with different PCIs in the super cell.

There may be multiple SI messages comprising sets of other SIBs, which may be configured in SIB1. The enhancement may apply to a subset of or all SI messages. Since per PCI delivery of SIB1 may be operated with (e.g., assumed), the different SIB1s may comprise different configurations in some respects. For example, different SIB1s may indicate that different sets of SI messages may be delivered with an anchor PCI.

In certain representative embodiments, joint transmission by multiple TRPs may correspond to a single frequency network (SFN) transmission, such as where the TRPs transmit a same signal and/or channel. In some embodiments, joint transmission by multiple TRPs may correspond to transmission of different signals and/or channels on overlapping time-frequency resources, such as by using different antenna ports associated with PDSCH transmission. For example, in a SIB1, an anchor PCI may be indicated for all SI messages, e.g., directly in the SI-SchedulingInfo IE, or per SI message, e.g., in the SchedulingInfo IE or the SIB-TypeInfo IE. According to embodiments, a WTRU 102 (e.g., UE) may assume that the broadcast status, e.g., ‘broadcasting’ or ‘not broadcasting’, of an SI message, as indicated in SIB1, may be the same across the SIB1s corresponding to all PCIs or a subset of the PCIs in the super cell, e.g., a subset of PCIs for which the SIB1 may indicate the same anchor PCI for the SI message. All PCIs or a subset of the PCIs of the super cell may belong to the same SI area, e.g., by having the same SI area ID indicated in the corresponding SIB1s.

### DCI-Based Indication

The anchor PCI may be indicated by the DCI carried by the PDCCH, for example as an index p in [symbol] .

According to embodiments, SIB1 may configure a subset of PCIs from [symbol] from which the DCI may indicate an anchor PCI. This may reduce DCI overhead if the size of [symbol] may be large.

The first PCI may or may not be included among the PCIs that can be indicated by the DCI. In one case, a bit in the DCI may indicate if the first PCI is to be used or if the anchor PCI indicated in SIB1 is to be used.

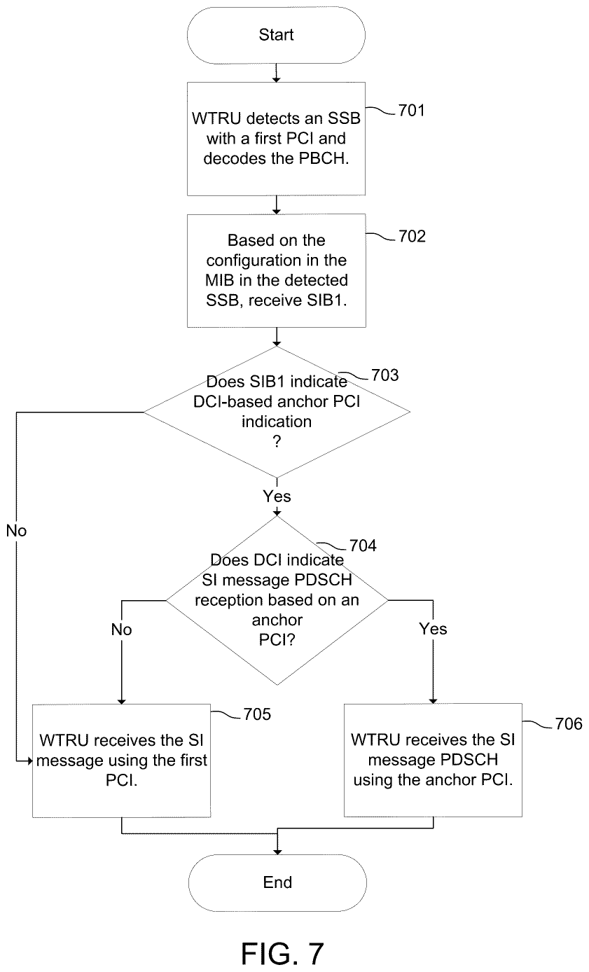

An exemplary WTRU (e.g., UE) procedure is shown in FIG. 7. Step 701 and step 702 may follow the WTRU (e.g., UE) procedure in FIG. 6. SIB1 may indicate if DCI-based anchor PCI indication is to be used. If the WTRU 102 (e.g., UE) in step 703 determines that it is not, the WTRU 102 (e.g., UE) may use legacy SI message reception using the first PCI. If the WTRU 102 (e.g., UE) in step 703 determines that DCI based anchor PCI indication is to be used, it may proceed to determine if the decoded DCI indicates if the PDSCH carrying the SI message is to be received using the first PCI (as in legacy operation) or using the anchor PCI. If the former, the WTRU 102 (e.g., UE) may proceed to step 705 and/or may receive the PDSCH using the first PCI.

If the latter, the WTRU 102 (e.g., UE) may proceed to step 706 and/or may receive the PDSCH using the anchor PCI.

### Other SIB Acquisition Using Group of SSBs

The PDCCH monitoring occasions for scheduling PDSCH carrying SI messages corresponding to different SSBs may be time multiplexed in legacy 5G NR. Typically, the corresponding PDSCHs may be (e.g., also) time multiplexed. The time multiplexing approach may have the benefit that it may allow analog beamforming implementations and allocation of all DL transmit power to the SI message PDCCH/PDSCH in single-TRP cells. A disadvantage may be that it may occupy many time-frequency resources, and in particular many resources in time, which may result in high network power consumption. Time multiplexing may result in longer SI acquisition latency as a WTRU 102 (e.g., UE) may (e.g., need to) wait for the SI message transmission occasion corresponding to the detected SSB.

In cell-free MIMO deployment, an alternative approach may be suitable. A super cell with many TRPs may not be limited to use a single beam at a time and simultaneous multi-TRP transmission can boost total DL transmit power.

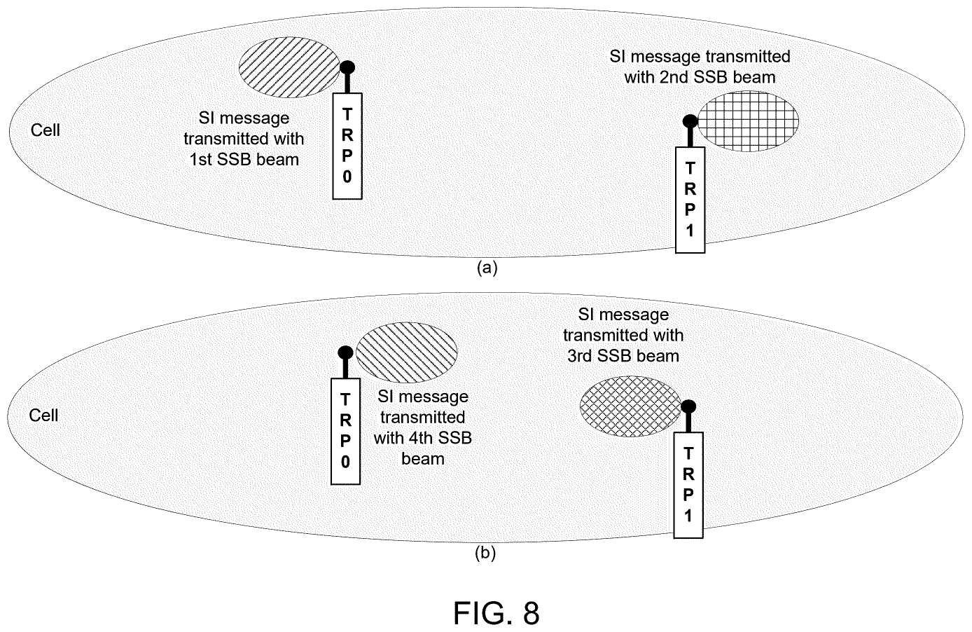

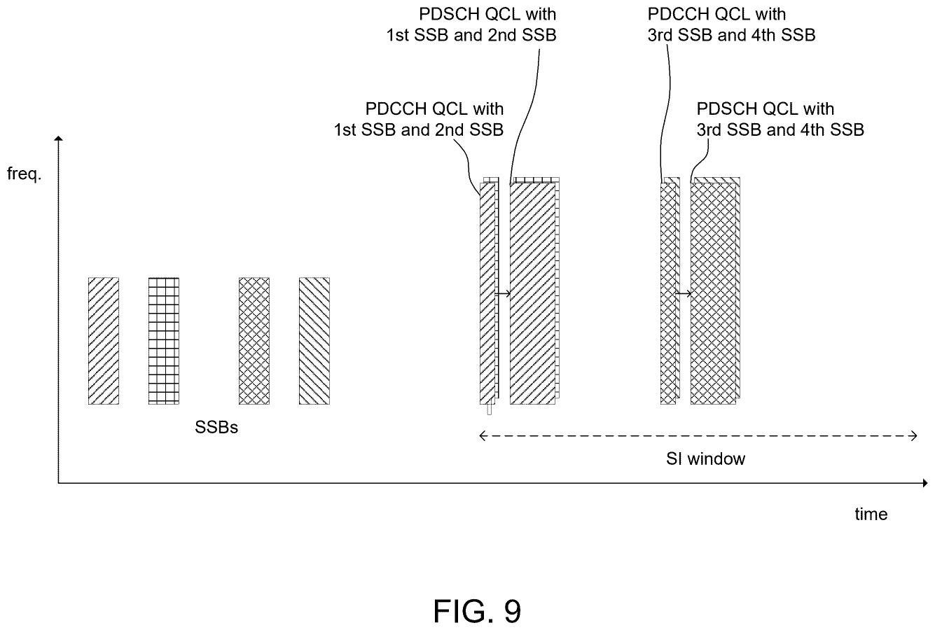

For example, consider the deployment in FIG. 3 with a legacy cell with two TRPs, each providing two SSB beams in 4 SSB transmission occasions. The TRPs may employ analog beamforming, so the TRP can transmit one SSB beam at a time. In this example, TRP 0 transmits the 1st SSB and 4th SSB, while TRP 1 transmits the 2nd SSB and 3rd SSB. Due to the multi-TRP cell, joint multi-TRP transmission of an SI message may be feasible. For example, in a first SI message occasion, illustrated in FIG. 8(a), the PDCCH and PDSCH may be jointly transmitted from TRP 0 using the 1st SSB beam and from TRP 1 using the 2nd SSB beam. In a second SI message occasion, illustrated in FIG. 8(b), the PDCCH and PDSCH may be jointly transmitted from TRP 0 using the 4th SSB beam and from TRP 1 using the 3rd SSB beam. The example is further illustrated in FIG. 9. The 1^{st} and 2^{nd} SSB may be grouped for a 1st SI message occasion in an SI window (corresponding to the SI message) and the 3^{rd} and 4^{th} SSB may be grouped for a 2^{nd} SI message occasion in the SI window. A WTRU 102 (e.g., UE) may operate with (e.g., assume that) the PDCCH and PDSCH in the SI message occasion being QCL with the SSBs in the corresponding SSB group.

Note that a 1-port PDCCH may be jointly transmitted using multiple SSB beams in this example (e.g., in an SFN manner), even though the figure may give the impression of having a two-layer PDCCH. Similarly, the PDSCH carrying the SI message may be a 1-port PDSCH jointly transmitted using multiple SSB beams. The PDSCH may be a multi-port PDSCH with a first antenna port being QCL with a first set of SSBs in the group, e.g., a first SSB, and a second antenna port being QCL with a second set of SSBs in the group, e.g., a second SSB, etc. According to embodiments, the PDSCH may be multi-port with multiple ports being QCL with the SSBs in an SSB group.

According to embodiments, an SI message PDCCH and/or PDSCH may be transmitted with a multi-port transmit diversity scheme, such as space-time block coding (STBC), or space-frequency block coding (SFBC). The different ports (or sets of ports) may be QCL with different sets of SSBs. For example, in a 2-port Alamouti scheme, the first port may be QCL with a first SSB (or a first group of SSBs) and the second port may be QCL with a second SSB (or a second group of SSBs).

The different SSB groups to use in different SI message occasions may be indicated in SIB1.

For example, SIB1 may indicate an SSB group size. SIB1 may indicate a set of SSBs, e.g., the actually transmitted SSBs. The SSB groups could (e.g., then) be determined by the WTRU 102 (e.g., UE) according to a rule.

In one example, with an SSB group size of G, and K SSBs or actually transmitted SSBs, a first SSB group could be determined as the first G SSB (in time, or with lowest SSB index), a second SSB group could be determined by the next G SSBs, etc., until the [K/G] groups have been determined. Note that K may correspond to the maximum number of SSBs (for the frequency band), e.g., if the search space for monitoring PDCCH for other SIBs is the same as the search space for monitoring PDCCH for SIB1 reception.

In another example, the first [K/G] SSB may be assigned, e.g., in order, to the [K/G] SSB groups, respectively, the next [K/G] SSBs may be assigned to the same groups, e.g., in the same order, etc., until all SSBs have been assigned to SSB groups. An SSB group may be labeled with an SSB group index, for example, between 0 and [K/G]−1.

In a legacy system, K sequential PDCCH monitoring occasions (for other SIB reception) may correspond to K SSBs, e.g., with wrap around from the last SSB to the first SSB within an SI window, with K corresponding to the maximum number of SSBs or the number of actually transmitted SSBs in various cases. In the embodiments above, there may be [K/G] sequential PDCCH monitoring occasions instead, e.g., corresponding to different SSB group indices. According to embodiments, the [K/G] monitoring occasions may not be necessarily sequential. For example, every G^{th} monitoring occasion may be used instead.

According to embodiments, G=K, i.e., there may be one SSB group comprising all K SSBs.

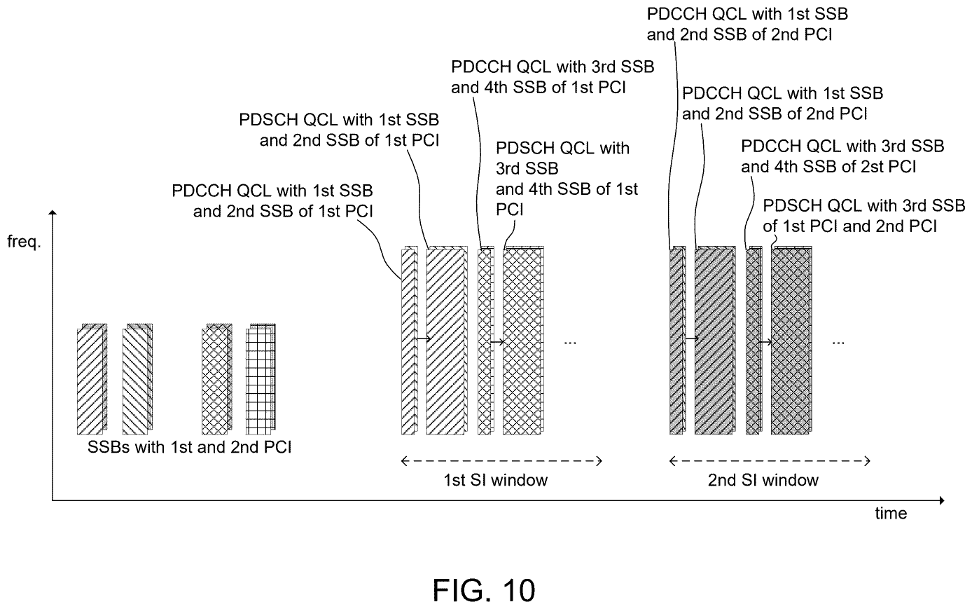

FIG. 10 illustrates SI message transmission using SSB groups in super cell with multiple PCIs.

The method with SSB groups may be applied also in a super cell with SSBs with multiple PCIs. For example, consider a deployment in which 4 SSBs with a 1st PCI and 4 SSBs with a 2nd PCI are transmitted in a super cell. In this example, the same SSB grouping may be done separately for the 1st and 2nd PCI, thereby further reducing the resource overhead. In this example, the 1st SI windows corresponding to the 1st PCI may be different from the 2nd SI window corresponding to the 2nd PCI, e.g., due to different SI windows configurations in the SIB1s for the 1st and 2nd PCIs.

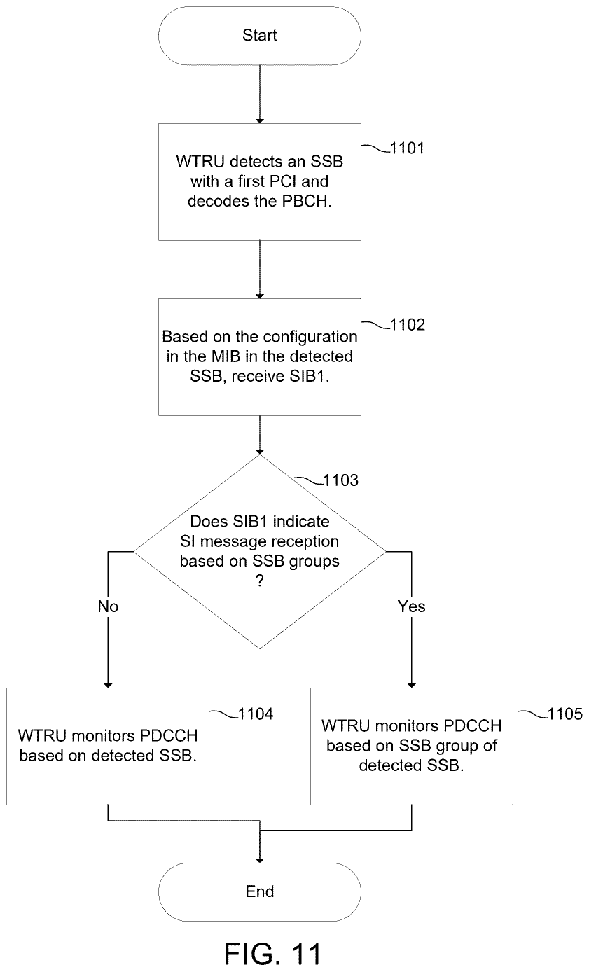

An exemplary procedure is shown in FIG. 11. Step 1101 and step 1102 may follow the WTRU (e.g., UE) procedure in FIG. 6. In step 1103, the WTRU 102 (e.g., UE) may determine if monitoring occasions of PDCCH that may schedule PDSCH that may carry an SI message may be based on SSB groups. If not, the WTRU 102 (e.g., UE) may proceed to step 1104 and may determine PDCCH monitoring occasions, for example, based on the index of the detected SSB, e.g., the index (e.g., ordinal position) among the actually transmitted SSBs, e.g., as in legacy procedures. If so, the WTRU 102 (e.g., UE) may proceed to step 1105, may determine the SSB group of the detected SSB, and may determine PDCCH monitoring occasions, for example, based on the SSB group of the detected SSB, e.g., as disclosed above. For the PDCCH monitoring, the WTRU 102 (e.g., UE) may operate with (e.g., assume that) the PDCCH being QCL with all the SSBs in the SSB group of the detected SSB. According to embodiments, the WTRU 102 (e.g., UE) may operate with (e.g., assume that) the PDCCH being QCL (e.g., just) with the detected SSB. For the PDSCH reception, the WTRU 102 (e.g., UE) may operate with (e.g., assume that) it being QCL with the SSBs in the SSB group or just with the detected SSB.

### Combining Anchor PCI and SSB Groups

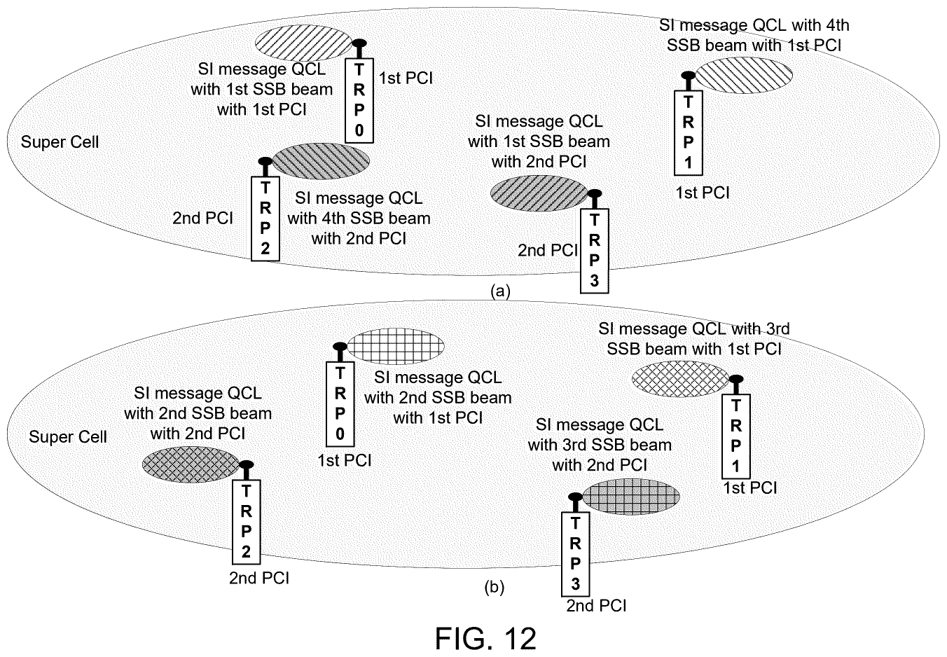

Enhanced acquisition of other SIBs using an anchor PCI may be combined with SSB groups. Consider the scenario in which 4 SSBs with a 1^{st} PCI may be transmitted in a super cell, e.g., from TRP 0 and TRP 1, and 4 SSBs with a 2^{nd} PCI may be transmitted in the super cell, e.g., from TRP 2 and TRP 3. In a first transmission occasion, the four TRPs could jointly transmit PDCCH and PDSCH, each using a first SSB beam, as illustrated in FIG. 12(a). In a second transmission occasion, the four TRPs could jointly transmit PDCCH and PDSCH, each using a second SSB beam, as illustrated in FIG. 12(b).

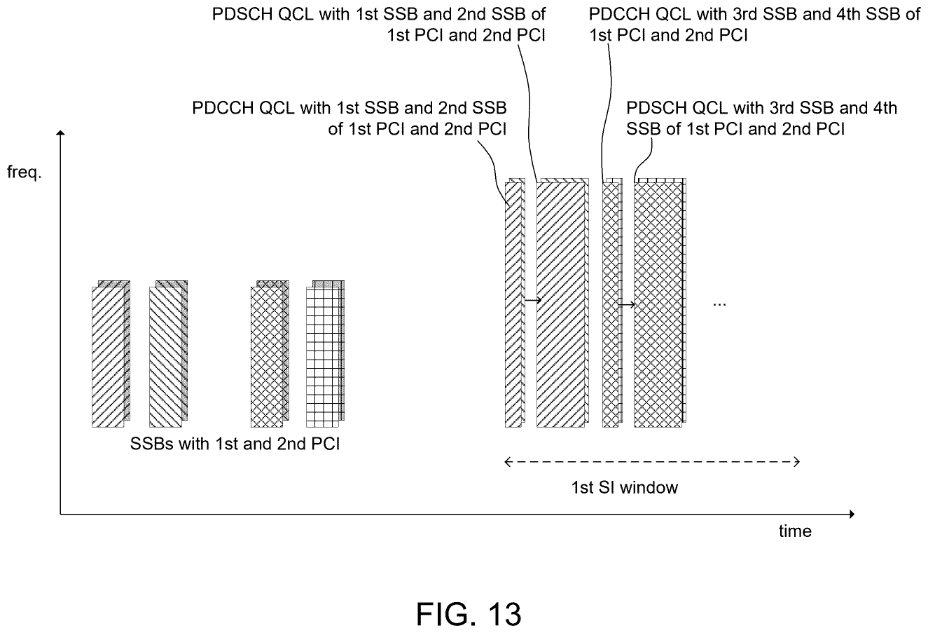

Joint multi-TRP transmission of an SI message using anchor PCI and SSB groups is illustrated in FIG. 13. The PDCCH monitoring occasions for the SSB groups may be configured in the SIB1s to overlap for the 1^{st} and 2^{nd} PCIs. A WTRU 102 (e.g., UE) that has detected an SSB with the 2^{nd} PCI may use the 1^{st} PCI as anchor PCI in the case of (e.g., when) receiving the PDCCH and/or the scheduled PDSCH. As an example, consider a first WTRU (e.g., UE) that has detected the 1^{st} SSB with the 1^{st} PCI, a second WTRU (e.g., UE) that has detected the 2^{nd} SSB with the 1^{st} PCI, a third WTRU (e.g., UE) that has detected the 1^{st} SSB with the 2^{nd} PCI, and a fourth WTRU (e.g., UE) that has detected the 2^{nd} SSB with the 2^{nd} PCI. The first and second WTRU (e.g., UE) may have received a SIB1 for the 1^{st} PCI and the third and fourth WTRU (e.g., UE) may have received a SIB1 for the 2^{nd} PCI. However, all four WTRUs 102 (e.g., UEs) may receive the same PDCCH in the first PDCCH monitoring occasion in, and (e.g., then) the same PDSCH that may be scheduled by the PDCCH. The SI message (PDCCH and/or PDSCH) may be jointly transmitted with SSB beams corresponding to the four SSBs detected by the four WTRUs 102 (e.g., UEs).

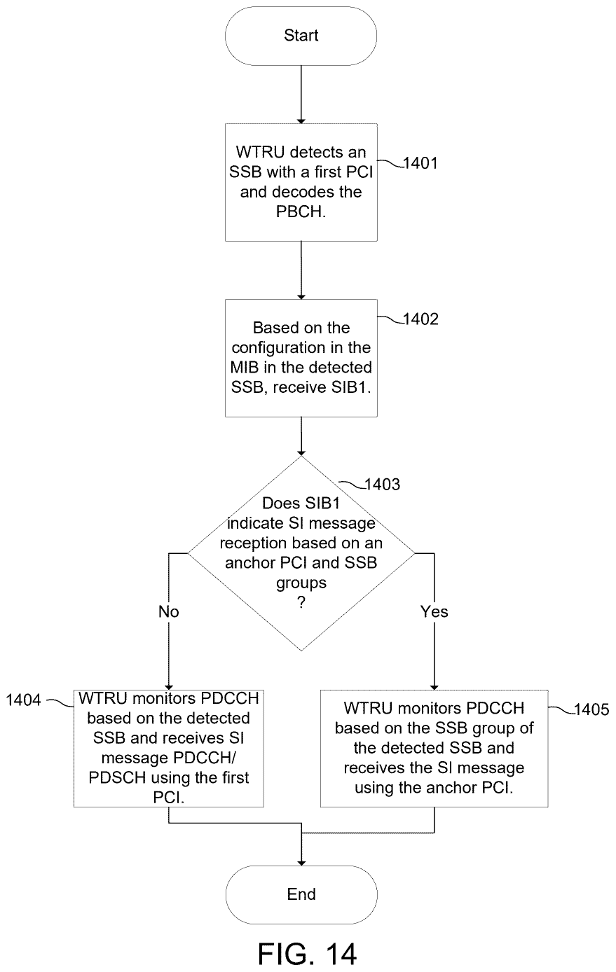

An exemplary procedure may be shown in FIG. 14. Step 1401 and step 1402 may follow the WTRU (e.g., UE) procedure in FIG. 6. In step 1403, the WTRU 102 (e.g., UE) determines if monitoring occasions of PDCCH that may schedule PDSCH that may carry an SI message may be based on SSB groups and if the reception of the SI message is based on an anchor PCI. If not, the WTRU 102 (e.g., UE) may proceed to step 1404 and may determine PDCCH monitoring occasions based on the index of the detected SSB and may receive the SI message using the first PCI. If so, the WTRU 102 (e.g., UE) may proceed to step 1405, may determine the SSB group of the detected SSB, and may determine PDCCH monitoring occasions based on the SSB group of the detected SSB, e.g., as disclosed above, and that the SI message may be received using the anchor PCI.

### Considerations on Legacy WTRU (e.g., U E) Operation

A legacy WTRU (e.g., UE) in the super cell may be able to detect an SSB and may acquire a corresponding SIB1 based on legacy procedures. With the enhancements discussed above, the legacy WTRU (e.g., UE) might not be able to acquire other SIBs. It may be suitable to indicate that the corresponding SI messages may not be broadcasted in the cell using legacy signaling, e.g., set corresponding broadcast status as ‘notBroadcasting’ in SchedulingInfo in SIB1. In order to indicate to enhanced WTRUs (e.g., UEs) that an SI message may be broadcasted using an enhanced scheme, a third state may be introduced, e.g., ‘Broadcasting’, ‘notBroadcasting’, and the new ‘enhancedBroadcasting’. An additional flag may be introduced to indicate to an enhanced WTRU (e.g., UE) to that the SI message may be broadcasted with enhancement, even though the legacy broadcast status may be ‘notBroadcasting’. However, a SIB1 corresponding to the anchor PCI may indicate the SI message as broadcasting.

According to embodiments, a legacy WTRU (e.g., UE) may request transmission of other SIBs on the super cell, which may then be transmitted according to legacy procedures in the super cell. However, this may be an attractive approach (e.g., only) when there may be (e.g., only) a few legacy WTRUs (e.g., UEs) in the network. If legacy WTRUs (e.g., UEs) are still common, it may be better to indicate the super cell as barred (for legacy WTRUs (e.g., UEs)), e.g., in the MIB and/or in SIB1. If so, a new barred indication for enhanced WTRUs (e.g., UEs) may be added to SIB1. Furthermore, an enhanced WTRU (e.g., UE) may ignore the legacy barred indication in the MIB.

A legacy WTRU (e.g., UE) may access the super cell, or rather a legacy cell corresponding to a PCI in the super cell, as an SCell or PSCell, since the WTRU (e.g., UE) might not (e.g., need to) perform initial access on the super cell and may receive the other SIBs for the super cell through dedicated signaling. The SSBs in the super cell may not be enhanced, so they may be used in an SCell or PSCell for legacy procedures, such as synchronization and beam management.

For reference, an example procedure is described below, and may comprise any of the following steps:
A WTRU 102 (e.g., UE) may detect an SSB with a first PCI, including a PBCH.
The WTRU 102 (e.g., UE) may receive SIB1 based on the configuration in the PBCH in the detected SSB.
The SIB1 may indicate to the WTRU 102 (e.g., UE) that an SI message may be received using an anchor PCI, which is different from the first PCI.
The WTRU 102 (e.g., UE) may receive a PDCCH and a corresponding scheduled PDSCH that may carry the SI message, using the detected SSB with the first PCI as a QCL source, and otherwise using the anchor PCI for the PDCCH and PDSCH reception.

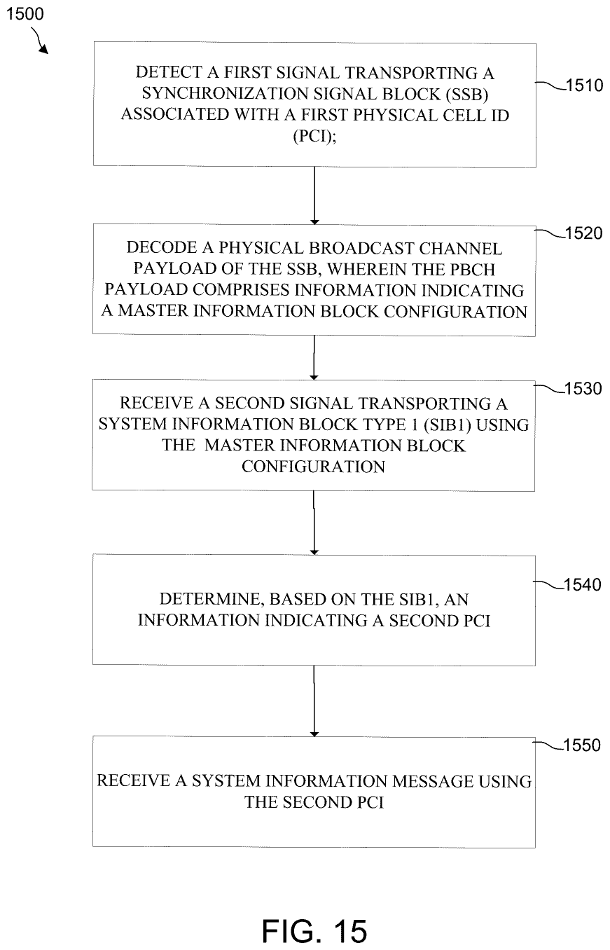

FIG. 15 illustrates an example of a method 1500 implemented by a WTRU.

Referring to FIG. 15, the representative method 1500 may include, at block 1510, detecting a first signal transporting a SSB associated with a first PCI. At block 1520, the representative method 1500 may include decoding a physical broadcast channel payload of the SSB, wherein the PBCH payload comprises information indicating a master information block configuration. At block 1530, the representative method 1500 may include receiving a second signal transporting a SIB1 using the master information block configuration. At block 1540, the representative method 1500 may include determining, based on the SIB1, an information indicating a second PCI. At block 1550, the representative method 1500 may include receiving a system information message using the second PCI.

According to embodiments, the second PCI is different from the first PCI.

According to embodiments, a second PCI indication is included in SIB1.

According to embodiments, a SSB group for SI message reception indication is included in SIB1.

According to embodiments, the detected SSB is in the SSB group.

According to embodiments, the representative method 1500 may include: receiving an SI message on time-frequency resources associated with the SSBs in the SSB group.

According to embodiments, the SI message is quasi co-location with the SSBs in the SSB group.

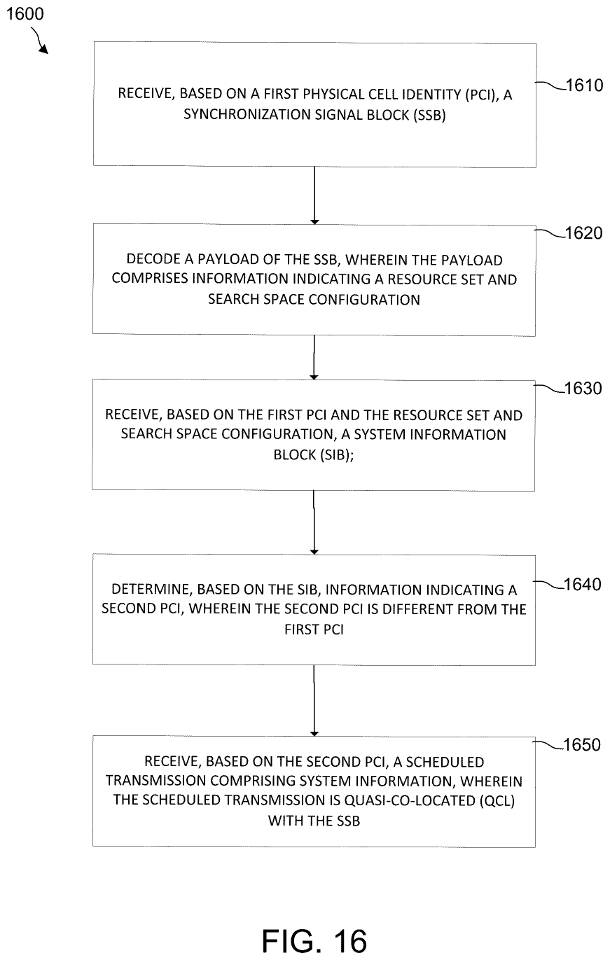

FIG. 16 illustrates an example of a method 1600 implemented by a WTRU.

Referring to FIG. 16, the representative method 1600 may include, at block 1610, receiving, based on a first PCI, an SSB. At block 1620, the representative method 1600 may include decoding a payload of the SSB, wherein the payload comprises information indicating a resource set and search space configuration. At block 1630, the representative method 1600 may include receiving, based on the first PCI and the resource set and search space configuration, a SIB. At block 1640, the representative method 1600 may include determining, based on the SIB, information indicating a second PCI, wherein the second PCI is different from the first PCI. At block 1650, the representative method 1600 may include receiving, based on the second PCI, a scheduled transmission comprising system information, wherein the scheduled transmission is QCL with the SSB.

According to embodiments, decoding the payload of the SSB comprises decoding a physical broadcast channel transmission payload.

According to embodiments, the scheduled transmission is included in a physical shared channel transmission.

According to embodiments, receiving the scheduled transmission comprises receiving a physical downlink control channel transmission scheduling the physical shared channel transmission.

According to embodiments, the physical shared channel transmission is received based on the second PCI.

According to embodiments, the SIB comprises information indicating one or more set of SSBs for system information message reception.

According to embodiments, the received SSB is included in a set of SSBs of the one or more set of SSBs.

According to embodiments, the representative method 1600 may include: receiving a system information message on time-frequency resources associated with the set of SSBs.

According to embodiments the scheduled transmission is quasi co-located with the set of SSBs.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method implemented by a wireless transmit/receive unit (WTRU), comprising:
receiving, based on a first physical cell identity (PCI), a synchronization signal block (SSB);
decoding a payload of the SSB, wherein the payload comprises information indicating a resource set and search space configuration;
receiving, based on the first PCI and the resource set and search space configuration, a system information block (SIB);
determining, based on the SIB, information indicating a second PCI, wherein the second PCI is different from the first PCI; and
receiving, based on the second PCI, a scheduled transmission comprising system information, wherein the scheduled transmission is quasi-co-located with the SSB.

2. The method of claim 1, wherein decoding the payload of the SSB comprises: decoding a physical broadcast channel transmission payload.

3. The method of claim 1, wherein the scheduled transmission is included in a physical shared channel transmission.

4. The method of claim 3, wherein receiving the scheduled transmission comprises: receiving a physical downlink control channel transmission scheduling the physical shared channel transmission.

5. The method of claim 4, wherein the physical shared channel transmission is received based on the second PCI.

6. The method of claim 1, wherein the SIB comprises information indicating one or more set of SSBs for system information message reception.

7. The method of claim 6, wherein the received SSB is included in a set of SSBs of the one or more set of SSBs.

8. The method of claim 7, comprising: receiving a system information message on time-frequency resources associated with the set of SSBs.

9. The method of claim 8, wherein the scheduled transmission is quasi co-located with the set of SSBs.

10. A wireless transmit/receive unit (WTRU) comprising circuitry, including a transmitter, a receiver, a processor and memory, the WTRU being configured to:
receive, based on a first physical cell identity (PCI), a synchronization signal block (SSB);
decode a payload of the SSB, wherein the payload comprises information indicating a resource set and search space configuration;
receive, based on the first PCI and the resource set and search space configuration, a system information block (SIB);
determine, based on the SIB, information indicating a second PCI, wherein the second PCI is different from the first PCI; and
receive, based on the second PCI, a scheduled transmission comprising system information, wherein the scheduled transmission is quasi-co-located with the SSB.

11. The WTRU of claim 10, wherein the WTRU being configured to decode the payload of the SSB comprises: the WTRU being configured to decode a physical broadcast channel transmission payload.

12. The WTRU of claim 10, wherein the scheduled transmission is included in a physical shared channel transmission.

13. The WTRU of claim 12, wherein the WTRU being configured to receive the scheduled transmission comprises: the WTRU being configured to receive a physical downlink control channel transmission scheduling the physical shared channel transmission.

14. The WTRU of claim 13, wherein the physical shared channel transmission is received based on the second PCI.

15. The WTRU of claim 10, wherein the SIB comprises information indicating one or more set of SSBs for system information message reception.

16. The WTRU of claim 15, wherein the received SSB is included in a set of SSBs of the one or more set of SSBs.

17. The WTRU of claim 16, wherein the WTRU is configured to receive a system information message on time-frequency resources associated with the set of SSBs.

18. The WTRU of claim 17, wherein the scheduled transmission is quasi co-located with the set of SSBs.

19. The method of claim 7, wherein the set of SSBs of the one or more set of SSBs is included in a super cell.

20. The WTRU of claim 10, wherein the set of SSBs of the one or more set of SSBs is included in a super cell.
